(19) United States
(12) Patent Application Publication
(10) Pub. No.: US 2016/0224645 A1
(43) Pub. Date: Aug. 4, 2016

(54) SYSTEM AND METHOD FOR ONTOLOGY-BASED DATA INTEGRATION

(71) Applicant: Siemens Aktiengesellschaft, Munich (DE)

(72) Inventor: Jiangbo Dang, Cranbury, NJ (US)

(21) Appl. No.: 14/612,373

(22) Filed: Feb. 3, 2015

(51) Int. Cl. G06F 17/30

(52) U.S. Cl. CPC G06F 17/30569; G06F 17/30525; G06F 17/30958; G06F 17/3043; G06F 17/30917; G06F 17/30595; G06F 17/30554; G06F 17/30557

(57) ABSTRACT

Methods for building a semantic knowledge base for ontology-based data integration. A method includes receiving a semantic knowledge base related to an application domain, wherein the semantic knowledge base comprises a graph database and a global ontology schema, receiving a data collection related to an application domain, the data collection comprising structured data, semi-structured data, and unstructured data, annotating the unstructured data into annotated data using predefined metadata defined by the global ontology schema, mapping and converting the structured data and the semi-structured data to semantic data into the graph database, integrating the annotated data with the semantic data in the graph database, and storing the semantic knowledge base in a database.

### TECHNICAL FIELD

The present disclosure is directed, in general, to data storage and management systems, and in particular to cloud-based data storage and management.

### BACKGROUND OF THE DISCLOSURE

Increasing amounts of data are being stored in remote servers for online access, such as the Internet-accessible “cloud.” Improved systems are desirable.

### SUMMARY OF THE DISCLOSURE

Various disclosed embodiments include methods for building a semantic knowledge base for ontology-based data integration. A method includes receiving a semantic knowledge base related to an application domain, wherein the semantic knowledge base comprises a graph database and a global ontology schema, receiving a data collection related to an application domain, the data collection comprising structured data, semi-structured data, and unstructured data, annotating the unstructured data into annotated data using predefined metadata defined by the global ontology schema, mapping and converting the structured data and the semi-structured data to semantic data into a graph database, also known as a triple store, integrating the annotated data with the semantic data in the graph database, and storing the semantic knowledge base in a database. Herein, graph database and triple store are used interchangeably.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2 illustrates ontology based data integration of a semantic knowledge base from heterogeneous data sources in accordance with disclosed embodiments;

FIG. 3 illustrates a customer survey ontology overview in accordance with disclosed embodiments;

FIG. 4 illustrates an overview of a data integration structure in accordance with disclosed embodiments;

FIG. 5 illustrates the architecture of a customer survey analyzer in accordance with disclosed embodiments;

FIG. 6 illustrates a customer survey analyzer user interface in accordance with disclosed embodiments.

FIG. 7 illustrates a data view interface in accordance with disclosed embodiments;

FIG. 8 illustrates a feedback treemap interface in accordance with disclosed embodiments;

FIG. 9 illustrates a trend graph interface in accordance with disclosed embodiments;

FIG. 10 illustrates a linked terms interface in accordance with disclosed embodiments;

FIG. 11 illustrates a geographic map interface in accordance with disclosed embodiments; and

FIG. 12 depicts a flowchart of a process for building a semantic knowledge base for ontology-based data integration in accordance with disclosed embodiments that may be performed, for example, by a PLM or PDM system.

### DETAILED DESCRIPTION

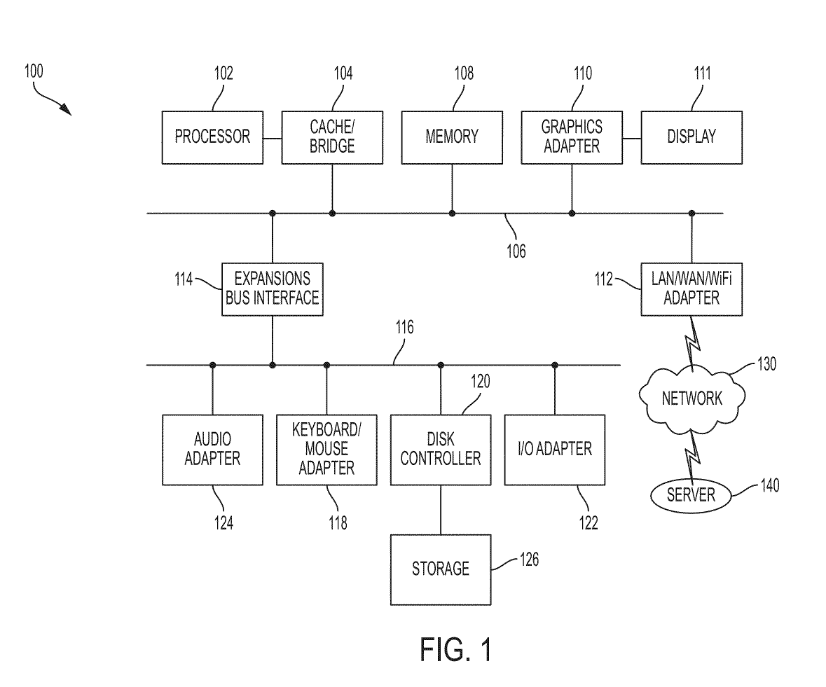

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Big data are high-volume, high-velocity, and high-variety information assets that require new forms of processing for enhancing decision making, insight discovery and process optimization. From a data integration perspective, big data is utilized by combining the “structured” internal data that companies have always used for reports and the public “unstructured” data like social media streams and freely available government data or trending data (on traffic, agriculture, crime, etc.). Combining these types of data provides greater insights into how customers feel about products versus competitors (from the social media streams), anticipation to changes in product demand or the volatility of markets, as well as other benefits.

Current data integration solutions utilize hard-coded applications for specific work, which are expensive, error-prone, easy to break, and hard to maintain. Each type of data source requires development of unique data connectors, and the mapping and integration of the data requires development of hard coded applications. Any changes on the original data sources or hard coded applications break the data connectors or the mapping and integration of the data.

Disclosed semantic data integration methods provide business applications effective and efficient utilization of various distributed data sources based on emerging semantic technologies, including domain ontology development, semantic tagging, and semantic data integration. Domains are mechanisms use to isolate executed software application. Ontology is the formal, explicit specification of a shared conceptualization which is used for naming and defining the types, properties, and interrelationship of entities and provides a shared vocabulary, which can be used to model domains. Domain ontologies are declarative knowledge models, defining essential characteristics and relationships for specific domains, utilized as a semantic foundation for annotating and integrating distributed data sources. The resulting annotated data can subsequently be integrated to semantic data, which provides a unified data view to business applications over a set of heterogeneous data sources. The semantic data integration methods utilize semantics technologies to reconcile the big data, enabling the building of more powerful business applications.

FIG. 1 illustrates a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

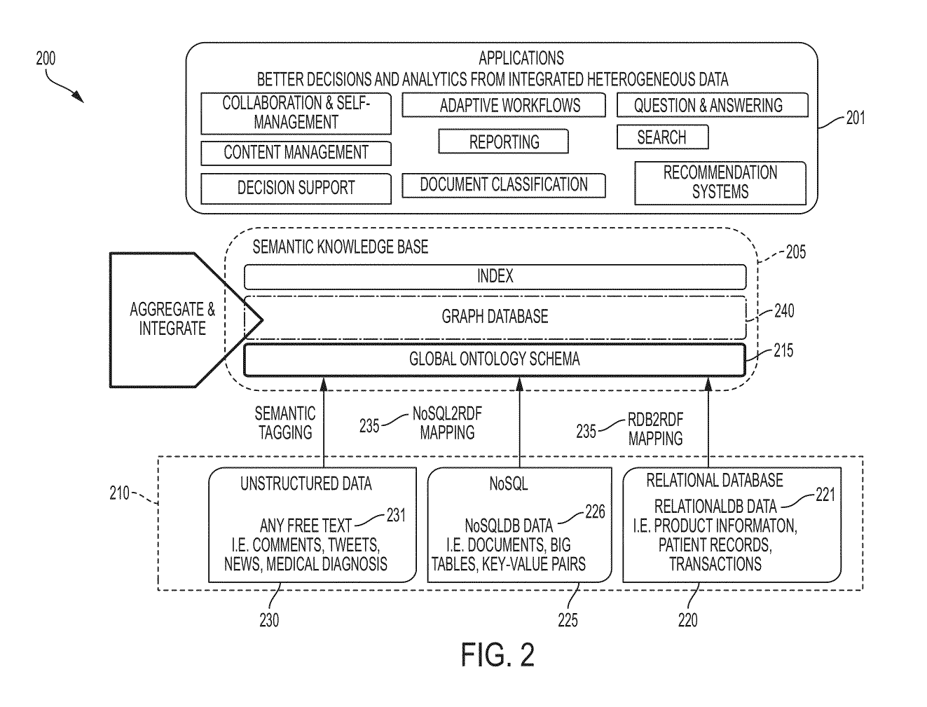

FIG. 2 illustrates ontology based data integration 200 of a semantic knowledge base 205 from heterogeneous data sources 210 in accordance with disclosed embodiments. Semantic knowledge bases 205 use global ontology schema 215 to structure the information and to provide a shared vocabulary for a specific application domain 201. Beyond structuring the information, global ontology schemas 215 provide means to integrate data from multiple heterogeneous data sources 210. The ontology based data integration 200 approach may be classified as global-as-view, because the global ontology schema 215 is defined in terms of the source. Effectiveness of ontology based data integration 200 is closely tied to the consistency and expressivity of the global ontology schema 215 used in the integration process. The application domains 201 are mechanisms for isolating executed software applications to not affect other software applications structured with unique virtual address spaces, which associate a semantic name to an entity. As a non-limiting example, the Geonames application domain is a geographical database covering all countries and addresses used for defining location data. Global ontology schema 215 can be implemented, in some examples using XML schema techniques.

The heterogeneous data sources 210 include structured data 220, semi-structured data 225, and unstructured data 230. The structured data 220 includes, as a non-limiting example, rational database data 221. The semi-structured data 225 includes, as a non-limiting example, NOSQL® database data 226. The unstructured data 230 includes, as a non-limiting example, free text 231. The structured data 220 and semi-structured data 225 are integrated with specific data source mappers 235 and the unstructured data 230 is tagged to the global ontology schema concepts. The resulting semantic knowledge base 205 constitutes a complete (integrated, person-centered, longitudinal), consistent (normalized, semantically-aligned), and coherent (reconciled, contextually-positioned) data from fragmented and heterogeneous data sources 210.

The ontology based approach integrates customer survey related data originally stored in, as non-limiting examples, EXCEL® spreadsheets (unstructured data 230) and NOSQL® databases (semi-structured data 225). A semi-structured database provides storage and retrieval of semi-structured data 225 using a looser consistency model rather than the structured data 220 of traditional relational databases. After integrating data into the graph database 240, the customer survey analyzer tool uses the graph database 240 to search for needed information and allows interactively exploring search results via a user-friendly web based interface.

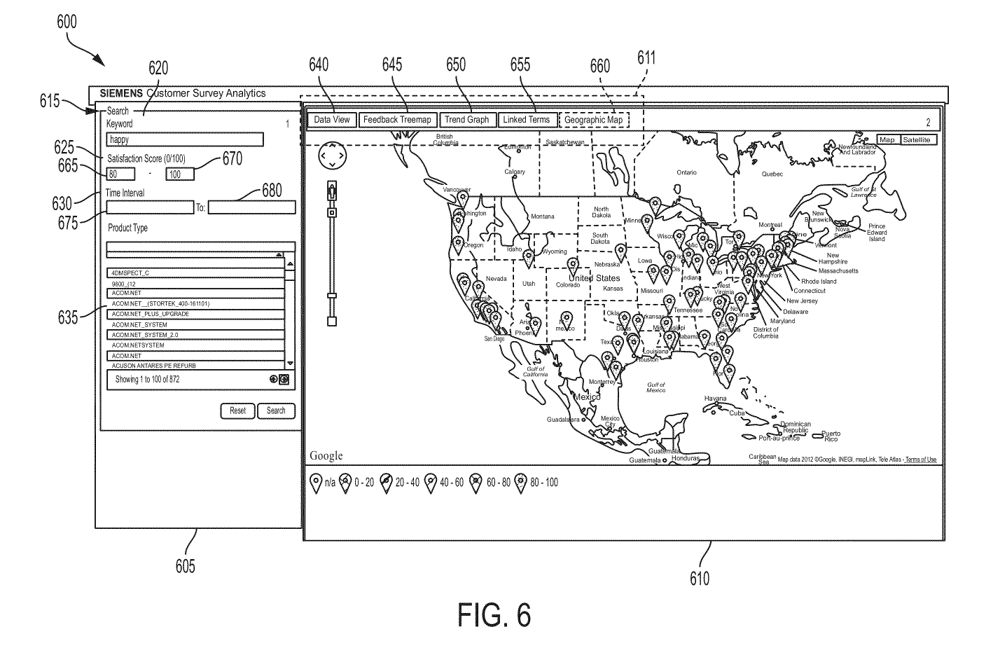

According to this disclosure, the semantic data integration methods are illustrated using an example customer survey analysis application. One of the most common means to measure customer satisfaction is through customer surveys, which are normally stored as unstructured data 230. Various other information sources, typically stored as structured data 220 or semi-structured data 225, related to customer, products, services, etc. are integrated to obtain helpful knowledge from these customer surveys. The presented semantic data integration methods for creation of a semantic knowledge base 205 are illustrated using an ontology based customer survey analysis tool that: (1) integrates information from spreadsheets and structured and semi-structured databases into a graph database 240; (2) makes use of this graph database 240 to search for the needed information; and (3) allows interactively exploring search results via user-friendly web based interface as illustrated in FIG. 6 in accordance with disclosed embodiments.

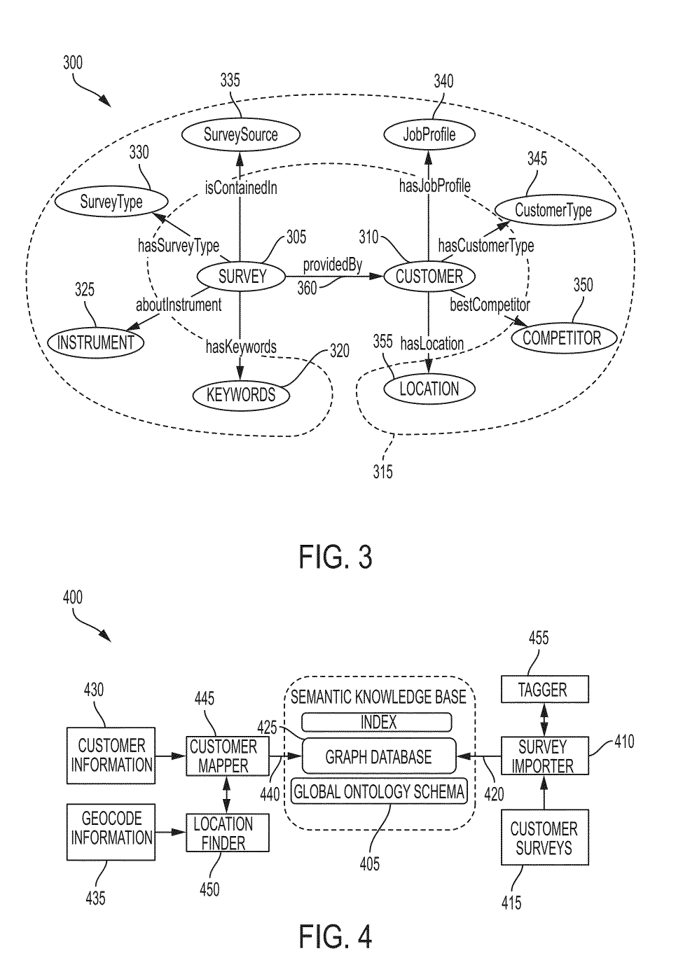

FIG. 3 illustrates a customer survey ontology overview 300 in accordance with disclosed embodiments. The global ontology schema is created by a domain expert manually in resource description framework (RDF). The two main concepts of the ontology overview 300 are the survey 305 and the customer 310 and they are described by other metadata 315, as non-limiting examples, keywords 320, instrument 325, surveytype 330, surveysource 330, jobprofile 335, customer type 340, competitor 345, and location 350. These other concepts are described by many data properties not illustrated in the FIG. 3. These data properties represent values of the survey fields, such as, “timeCallBack” and “openComment.”

The “providedBy” property 360 is a key element of the global ontology schema in this example, which provides a connection between a survey 305 and a customer 310. Semantically, the “providedBy” property 360 points out the customer 310 that filled out the survey 305. The following is a non-limiting example of coding for the OWL® description of the “providedBy” property 360. The “providedBy” property 360 connects the data from different sources to each other.

<Description rdf:about=“http://www.siemens.com/scr/
customer_survey.owl# providedBy”>

<rdfs:subPropertyOf rdf:resource=“http://www.siemens.com/scr/
customer _survey.owl#schemaRelatedOP”/>
<rdfs:domain rdf:resource=“http://www.siemens.com/scr/
customer_survey.owl#Survey”/>
<rdfs:range rdf:resource=“http://www.siemens.com/scr/
customer_survey.ot.rl#Customer”/>
<rdf:type rdf:resource=“http://www.w3.org/2002/07/
owl#ObjectProperty”/>

</Description>

FIG. 4 illustrates an overview of a data integration structure 400 in accordance with disclosed embodiments. The global ontology schema 405 covers all related concepts of the domain and is used when the survey importer 410 transmits the customer surveys 415 as annotated data 420 to the graph database 425 as instances of the global ontology schema 405 concepts. Other related data including customer information 430 and geocode information 435 is integrated as semantic data 440 to the graph database 425 through a customer mapper 445 and location finder 450.

The customer surveys 415 previously stored in spreadsheets are imported into the graph database 425 using a survey importer 410 module. The survey importer 410 maps each spreadsheet column into a property of the survey object and generates corresponding RDF descriptions. The following is a non-limiting example of coding for sample RDF schema descriptions of the customer survey data. The first description is the survey concept and the other three descriptions define properties of the survey concept.

</Desc<Description rdf:about=“ http://www.siemens.com/scr/
customer_suryey.owl#Survey”>

<rdfs:comment>An instance of Survey class consists of the values for
several fields in a survey.</rdfs:comment>
<rdf:type rdf:resource=“http://www.w3.org/2002/07/owl#Class”/>

</Description>

<Description rdf:about=“http://www.siemens.com/scr/
customer_survey.owl#timeCallBack”>
<rdfs:stibPropertyOf rdf:resource=“http://www.siemens.com/scr/
customer_survey.owl#originalfield”/>
<rdfs:domain rdf:resource=“http://www.siemens.com/scr/
customer_survey.owl#Survey”/>
<rdfs:range rdf:resource=“http://www.w3.org/2001/
XMLSchema#unsignedShort”/>
<rdf:type rdf:resource=“http://www.w3.org/2002/07/
owl#DatatypeProperty”/>

</Description>

<Description rdf:about=“http://www.Siemens.com/scr/
customer_survey.owl#openComment”>
<rdfs:subPropertyOf rdf:resource=“http://www.siemens.com/scr/
customer_survey.owl#originalfield”/>
<rdfs:domain rdf:resource=“http://www.siemens.com/scr/
customer_survey.ovl#Survey”/>
<rdfs:range rdf:resource=“http://www.w3.org/2001/
Xf1LSchema#string”/>
<rdf:type rdf:resource=“http://www.w3.org/2002/07/
owl#DatatypeProperty”/>

</Description>

<Description rdf:about=“http://www.siemens.com/scr/
customer_survey.owl#isContainedin”>
<rdfs:subPropertyOf rdf:resource=“http://www.siemens.com/scr/
customer_survey.owl#schemaRelatedOP”/>
<rdfs:domain rdf:resource=“http://www.siemens.com/scr/
customer_survey.owl#Survey”/>
<rdfs:range rdf:resource=“http://www.siemens.com/scr/
customer_survey.owl#SurveySource”/>
<rdfs:label>A survey record is contained in one and only one survey
source file.</rdfs:label>
<rdf:type rdf:resource=http://www.w3.org/2002/07/
owl#ObjectProperty/>
<rdf:type rdf:resource=“http://www.w3.org/2002/07/
owl#functionalProperty”/>

</Description>

The following is a non-limiting example of coding for a sample customer survey 415 instance with corresponding property instances. The sample customer survey 415 has a time callback value of 90. The customer also provided an open comment stating that the support was helpful. Since the “containedIn” property is an object property, it points to another resource defined separately.

<Description rdf:about=“http://www.siemens.com/scr/
customer_survey.owl# Survey_Service_Events_Raw_Data_{—}
lQ-4QlO.xls_1290”>

<ns1:timeCallBack xmlns:ns1=“http://www.siemens.com/scr/
customer_survey.owl#”

rdf:datatype=“http://www.w3.org/2001/XMLSchema#int”>90
</nal:time CallBack>

<nsl:openComment xmlns:nsl=“http://www.siemens.com/scr/
customer_survey.owl#”>Haven&#039;t had any problems.
Field service tech and tech support have been very helpful.</nsl:open
Comment>
<nsl:isContainedin xmlns:nsl=“http://www.siemens.com/scr/
customer_survey.owl#”
rdf:resource=“http://www.siemens.com/scr/
customer_survey.owl#SurveySource_Service_Events_Raw
Data 1Q -4Q10.xls”/>
<!-- Other properties -->

</Description>

The survey importer 410 module also utilizes a tagger module 455. The tagger module 455 extracts information related to products or services and tags them with related sentiment into annotated data 420. The following is a non-limiting example of coding for a sample sentiment definition in accordance with disclosed embodiments. These product, service, and sentiment information are contained in the global ontology schema using the “hasKeywords” property of the survey.

<Description
rdf:about=“http://www.siemens.com/scr/
customer_survey.owl#very_happy”>

<rdf:type rdf:resource=“http://www.siemens.com/scr/
customer_survey.owl#Sentiment”/>
<rdf:type rdf:resource=http://www.w3.org/2002/07/
owl#Namedindividual/>

</Description>

The data imported from the customer surveys 415 typically includes only the names and types of the customers. To be able to know more about them, data from other sources is integrated. In the implemented use case, the location information of the customers is originally stored in the customer information 425 in a semi-structured database, such as a MONGODB® database for a non-limiting example, and should be integrated as semantic data 440 to the graph database 425.

The following is a non-limiting example of coding for a sample customer information 430 document in a semi-structured database. The customer mapper 445 is responsible for creating corresponding semantic data 440, such as an RDF description, of the customer information 430 and associating the semantic data 440 with the respective annotated data 420 from the customer survey 415.

Db.contact_info.find<>.pretty<>

“_id” ; ObjectID<“51c17776c8ab66c8d75075fd”>,
“name” : “ ”,
“phone” : “ ”,
“address” : “ ”,
“city” : “EAST ORANGE”,
“state” : “NJ”,
“zip” : “ ”

The following is a non-limiting example of coding for an RDF description of location information in accordance with disclosed embodiments. The location information of the customer information 430 is defined using the geonames' global ontology schema and is connected to the right customer using the name information that is contained in both of the data sources. Geonames is a geographical database that covers all countries and related addresses.

<Description rdf:about=“http://www.slemens.comlscrlcustomer
survey.owl#locationl”>

<nsl:acctName xmlns:nsl=“http://www.siemens.com/scr/
customer_survey.owl#”>Siemens Corporate
Research</nsl:acctName>
<nsl:postalCode xmlns:nsl=“http://www.geonames.org/
ontology#”>08540</nsl:postalCode>
<nsl:parentCountry xmlns:nsl=http://www.geonames.org/
ontology#rdf:resource =“http://www.geonames.org /
ontology#A.PCLI”/>
<nsl:featureClass xmlns:nsl=http://www.geonames.org/
ontology#rdf:resource =“http://www.geonames.org/
ontology#P.PPL”/>
<rdf:type rdf:resource=“http://www.w3.org/2002/07/
owl#NamedIndividual”/>
<rdf:type rdf:resource=“http://www.geonames.org/
ontology#Feature”/>
<nsl:countryCode xmlns:nsl=“http://www.geonames.org/
ontology#”>US</nsl:countryCode>

</Description>

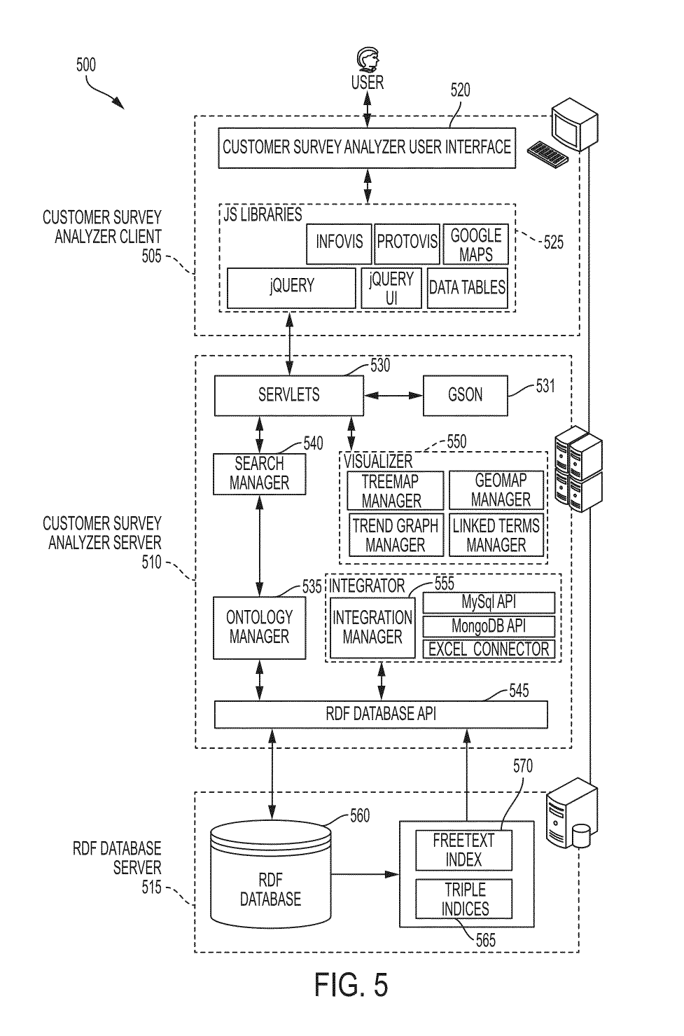

FIG. 5 illustrates the architecture of a customer survey analyzer 500 in accordance with disclosed embodiments. In certain embodiments, the customer survey analyzer 500 can be implemented as a JAVA® web application. The shaded modules of the customer survey analyzer client 505 and the customer survey analyzer server 510 illustrated are application specific modules developed from scratch, while the non-shaded modules are the external application program interfaces (API). Database related parts are illustrated in the RDF database server 515, such as an ALLEGROGRAPH® server.

The customer survey analyzer client 505 provides a user interface 520 through computer libraries 525, such as JAVASCRIPT® libraries. Examples of the computer libraries 525 used include, but are not limited to, the JQUERY® library for obtaining communication with servlets 530, the JQUERY UI® library for providing the theme of the user interface 520, DataTables for creating the tables in the data view, InfoVis for creating the feedback treemap and trend graph visualizations, Protovis for providing the linked term visualization, and GOOGLE® maps for creating the geographic map visualization. The JQUERY® library is a JAVASCRIPT® library that simplifies HTML/DOM manipulation, CSS manipulation, HTML event methods, effects and animations, AJAX, and utilities from JAVASCRIPT® libraries. The JQUERY UI® library is a plug-in for use with the JQUERY® library and is a curated set of user interface interactions, effects, widgets, and themes. The InfoVis Toolkit is a JAVASCRIPT® library that provides tools for creating interactive data visualizations for the web, including treemaps. Protovis is a JAVASCRIPT® library used to generate scalable vector graphics from data.

The customer survey analyzer server 510 processes user requests. The functionalities of the customer survey analyzer 500 are provided to the clients via the corresponding servlets 530. Servlets 530 interact with related modules to answer the user request and use Gson API 531 to create JAVASCRIPT® object notation (JSON) objects of the replies send by the modules. The Gson API 531 is a JAVA® library that is used to convert JAVA® objects into their JSON representations. The modules that implement operations provided by the server include, but not limited to, the ontology manager 535 which loads and indexes the semantic knowledge base, runs the queries forwarded by the search manager 540, and accesses the semantic knowledge base in the RDF database 560 via RDF database API 545; the search manager 540 for carrying out all search operations and generating corresponding query for each user search and sends it to the ontology manager 535; the visualizer 550 for creating the appropriate objects that will be converted to JSON and used by the user interface 520 components to create the visualizations, namely data view, treemap, linked terms view, trend graph and geographic map; and the integration described in the customer survey analyzer server 510. The RDF database API 545 is a purpose-built database for the storage and retrievel of triples through semantic queries. Using MYSQL® API, MONGODB® API and EXCEL® connector, the integration manager 555 carries out the integration process.

The customer survey semantic knowledge base is saved in the RDF database 560. Triple indices 565 of the RDF database server 515 are used to fasten the queries on the semantic knowledge base. To enable keyword searching, freetext indices 570 with the following properties are created using the RDF database server 515, ‘all’ for predicates, ‘true’ for index literals, ‘short’ for index resources, ‘object’ for parts indexed, ‘default’ for tokenizer, ‘3’ for minimum word size, ‘no changed needed to the default list’ for stop words, and ‘none’ for word filters.

FIG. 6 illustrates a customer survey analyzer user interface 600 in accordance with disclosed embodiments. In certain embodiments, the customer survey analyzer user interface 600 includes two main parts, a search window 605 and a visualization window 610. The search window 605 is the window at the left side of the user interface 600 and provides search options 615 to the user including, but not limited to, keyword 620, satisfaction score 625, time interval 630 and product type 635. The visualization window 610 is the window at the right side of the user interface 600 and provides different visualization options 611, as non-limiting examples, data view 640, feedback treemap 645, trend graph 650, linked terms view 655 and geographic map 660.

The keyword 620 search option filters surveys by the given keyword and lists only the customers and their surveys containing the given keyword as a value of a field. The keyword match works as for all values that contains the keyword, for example, for the value “know” as the given keyword, surveys with values containing the words “knowledge”, “pre-known”, etc. are listed.

The satisfaction score 625 filters surveys by their “likelyToRecommend” field and includes two inputs, a lower limit 665 and an upper limit 670. If the lower limit 665 is not specified, zero is the default value. Likewise, if the upper limit 670 is not specified, 100 is the default value. Satisfaction score values can be between 0 and 100.

The time interval 630 filters surveys by their “responseTime” field and includes two inputs. The first input is the earliest date 675 that the surveys are retrieved and the second input specifies the latest date 680 that the surveys are retrieved. If the earliest date 675 is not given, all the surveys until the given latest date 680 are retrieved. If the latest date 680 is missing, all the surveys retrieved since the specified earliest date 675 are listed.

The product type 635 filters surveys depending on the product type. In the surveys, the product type 635 is determined by the “aboutInstrument” field. Multiple product types 635 can be selected.

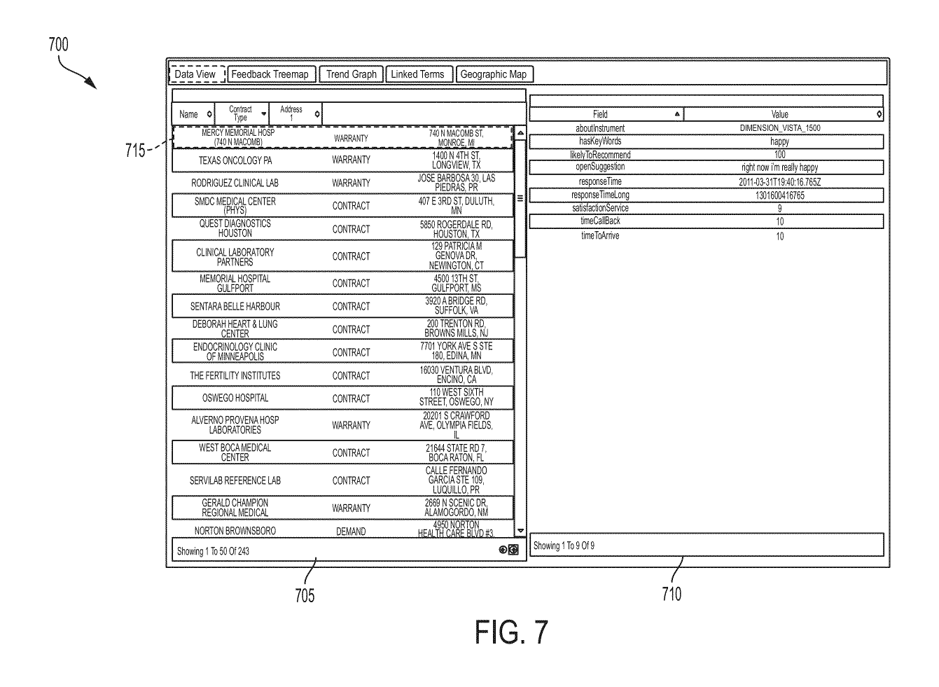

All visualization options 611 reflect the surveys & customers that are filtered through using the search options 615. The five different visualization options 611 are described below in FIGS. 7-11.

FIG. 7 illustrates a data view interface 700 in accordance with disclosed embodiments. The data view interface 700 provides a table view of search results. The first table displays the customer list 705 and the second table displays the survey values 710 of a selected customer 715. When a row is selected from the customer list 705, the second table displays survey values 710 of the selected customer 715. By default, the second window displays the survey values 710 of the first customer in the customer list 705.

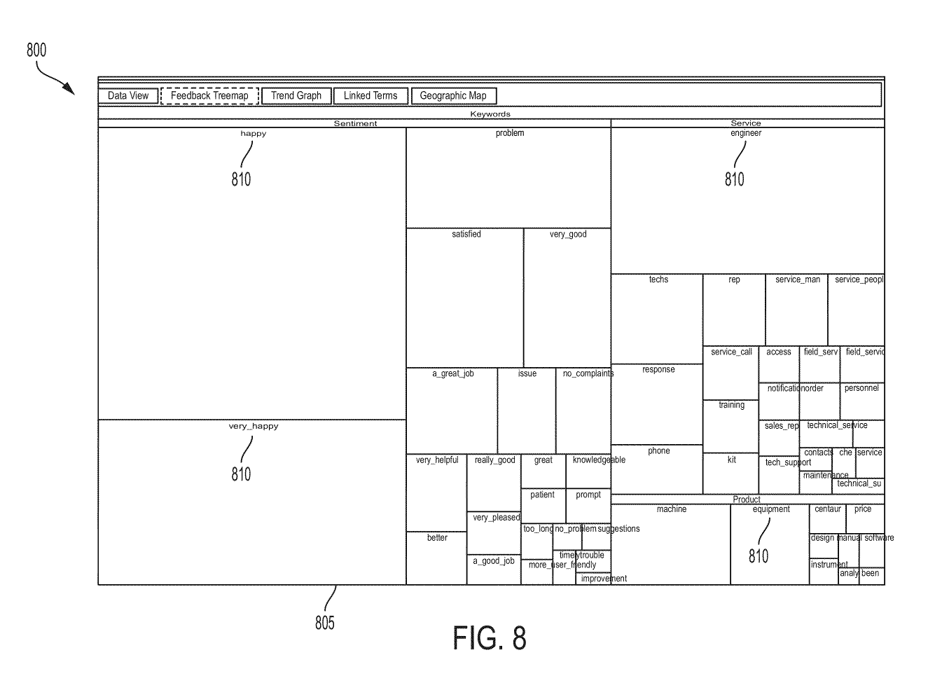

FIG. 8 illustrates a feedback treemap interface 800 in accordance with disclosed embodiments. The feedback treemap interface 800 provides a treemap 805 of the keywords 810 of current search results. When a keyword 810 is selected from treemap 805, the search results are filtered according to this keyword 810 and all other views and tables are updated with the new filtered results.

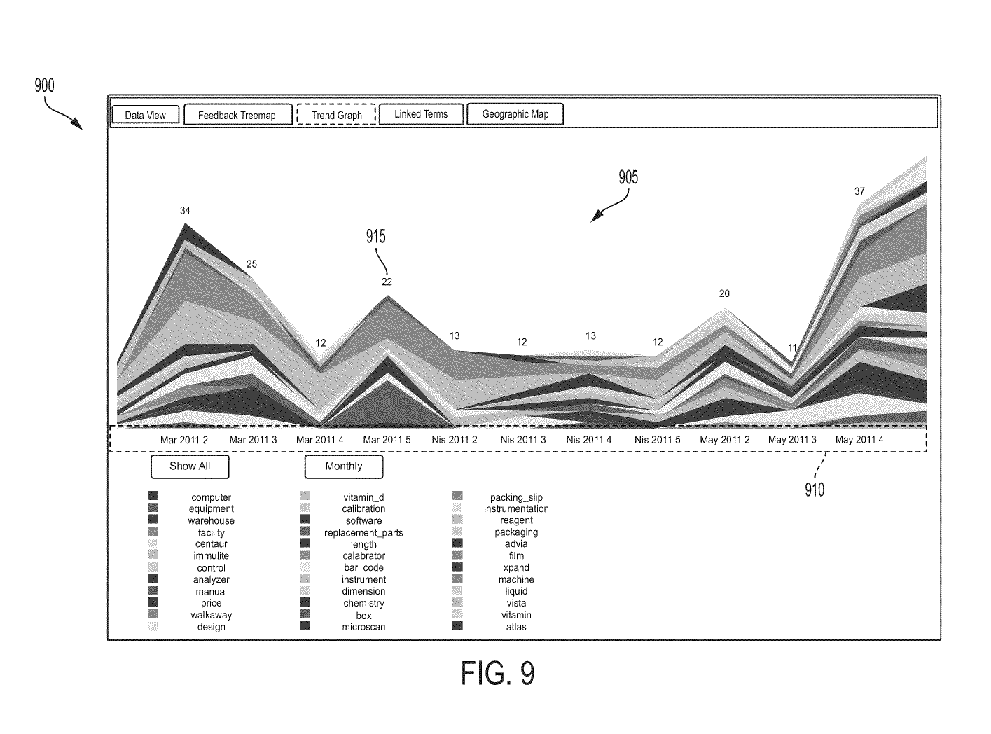

FIG. 9 illustrates a trend graph interface 900 in accordance with disclosed embodiments. The trend graph interface 900 provides a stacked area chart 905 of the product keyword trends and is based on the dates 910 of current search results and the count 915 that the keywords are mentioned.

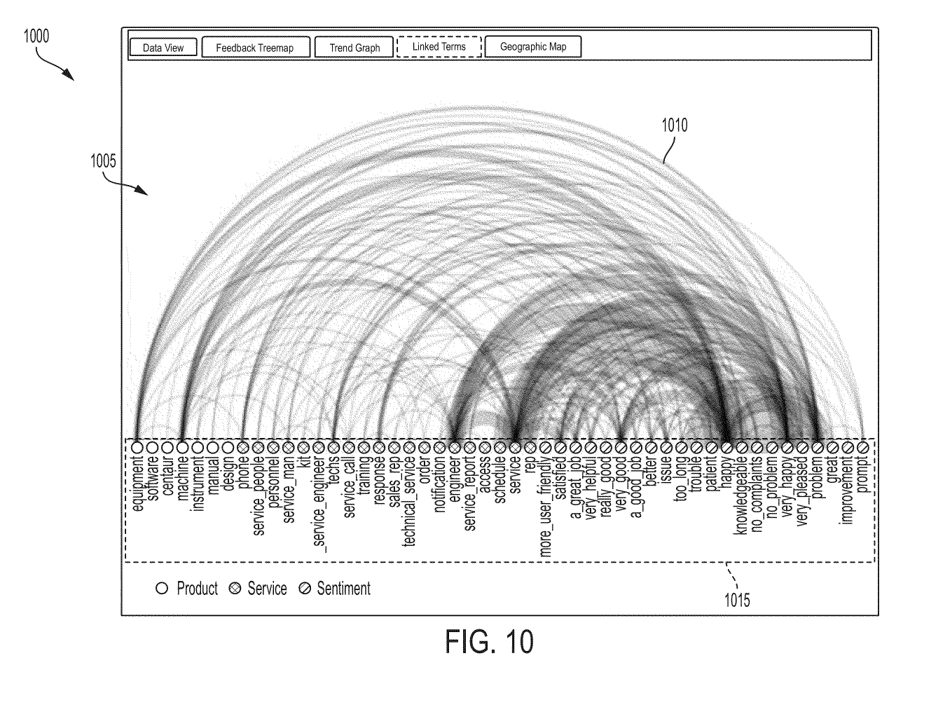

FIG. 10 illustrates a linked terms interface 1000 in accordance with disclosed embodiments. The linked terms interface 1000 provides an arc diagram 1005 that visualizes co-occurrences of the keywords of current search results. The thickness of the line 1010 between two keywords 1015 depends on the co-occurrences, with the thickness increasing by the increasing number of co-occurrences of the related keywords 1015.

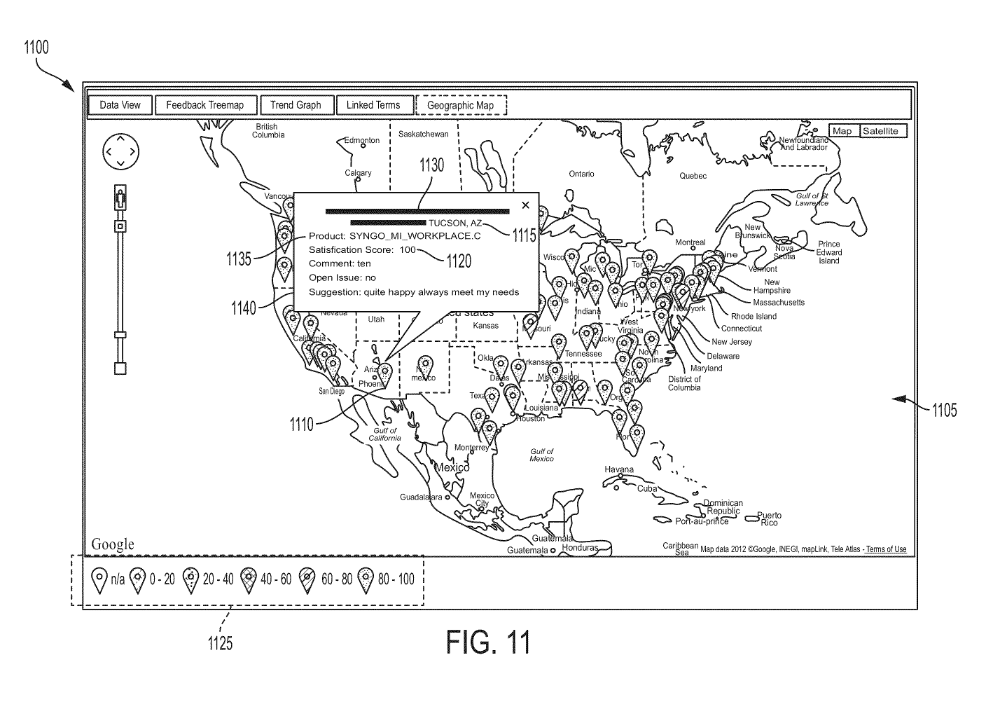

FIG. 11 illustrates a geographic map interface 1100 in accordance with disclosed embodiments. The geographic map interface 1100 provides a geographic view 1105 of the search results. Each search result is represented by a marker 1110 on the coordinates of the customer address 1115. The color of the marker 1110 depends on the customer's satisfaction score 1120. A legend 1125 for the color of the maker 1110 based on the customer's satisfaction score 1120 is provided below the geographic view 1105. Clicking a marker 1110 displays the customer name 1130, satisfaction score 1120 and the related product 1135 in the pop-up information window 1140.

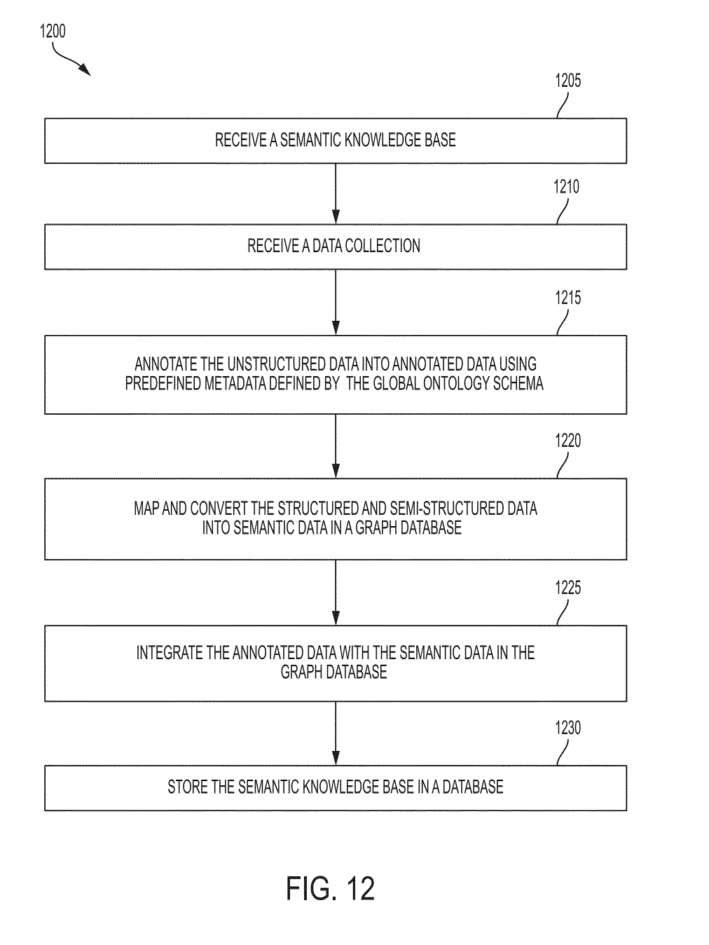

FIG. 12 depicts a flowchart of a process 1200 for building a semantic knowledge base for ontology-based data integration in accordance with disclosed embodiments that may be performed, for example, by a PLM or PDM system. The disclosed methods illustrate building a semantic knowledge base to integrate data from heterogeneous data sources of structured, semi-structured, and unstructured data.

In step 1205, the system receives a semantic knowledge base related to an application domain. The semantic knowledge base includes a graph database and a global ontology schema. The graph database stores semantic data, which is used with the global ontology schema for provided a unified data view on a user interface for applications. The global ontology schema represents specific subjects or concepts and applies meaning to terms based on the specific subjects and includes predefined metadata. In certain embodiments, the global ontology schema is created and defined using RDF. Application domains are structured with unique virtual address spaces, which associates a semantic name to an entity and are mechanisms for isolating executed software applications to not affect other software applications. As a non-limiting example, the GeoNames application domain is a geographical database covering all countries and addresses used for defining location data.

In step 1210, the system receives a data collection related to the application domain. The data collection includes structured data, semi-structured data, and unstructured data. The data collection is obtained from heterogeneous data sources, for example, SQL® databases (structured data), NOSQL® databases and web pages (semi-structured data), and free-text documents (unstructured data).

In step 1215, the system annotates the unstructured data into annotated data using predefined metadata defined by the global ontology schema. The annotation of unstructured data is tagged with predefined metadata including, but not limited to, names, entities, attributes, and definitions. The developed domain ontologies provide the predefined metadata. The annotated data is imported to the graph database using a survey importer. The survey importer utilizes a tagger for extracting information related to products or services and tags the unstructured data using the global ontology schema.

In step 1220, the system maps and converts the structured data and the semi-structures data to semantic data into the graph database of the semantic knowledge base. Semantic data is information that is meaningful to a machine, which is in contrast with hard coded data. The structured data and semi-structured data are integrated through data source specific mappers.

In step 1225, the system integrates the annotated data with the semantic data in the semantic knowledge base. Because all semantic tags are generated from a global metadata model defined in domain ontologies, various data sources can now be accessed at the semantic level. Integration of the annotated text data to the graph database provides a unified view of the data collection to be presented to users over the original data. The semantic knowledge base can be displayed in a web based interface with multiple visualization options including a data view, a feedback treemap, a trend graph, a linked terms view, and a geographic map.

In step 1230, the system stores the semantic knowledge base in a database. The resulting knowledge base constitutes a complete (integrated, person-centered, longitudinal), consistent (normalized, semantically-aligned), and coherent (reconciled, contextually-positioned) data from heterogeneous data sources and improves the development of applications that utilize a unified data view over semantic data.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC §112(f) unless the exact words “means for” are followed by a participle.

What is claimed is:

1. A method for building a semantic knowledge base for ontology-based data integration, the method performed by a data processing system and comprising:
receiving a semantic knowledge base related to an application domain, wherein the semantic knowledge base comprises a graph database and a global ontology schema;
receiving a data collection related to the application domain, the data collection comprising structured data, semi-structured data, and unstructured data;
annotating the unstructured data into annotated data using predefined metadata defined by the global ontology schema;
mapping and converting the structured data and the semi-structured data to semantic data into the graph database;
integrating the annotated data with the semantic data in the graph database; and
storing the semantic knowledge base in a database.

2. The method of claim 1, further comprising:
importing the annotated data to the graph database using a survey importer.

3. The method of claim 2, wherein the survey importer utilizes a tagger for extracting information related to products or services and tags the unstructured data to the global ontology schema.

4. The method of claim 1, wherein the structured data and the semi-structured data is converted to semantic data by source specific mappers.

5. The method of claim 1, wherein the unstructured data comprises free text, the semi-structured data comprises web page data, and the structured data comprises relational database data.

6. The method of claim 1, further comprising displaying the semantic data in a web based interface.

7. The method of claim 6, wherein the web based interface comprises multiple visualization options including a data view, a feedback treemap, a trend graph, a linked terms view, and a geographic map.

8. A data processing system comprising:
a processor; and
an accessible memory, the data processing system particularly configured to
receive a semantic knowledge base related to an application domain, wherein the semantic knowledge base comprises a graph database and a global ontology schema;
receive a data collection related to the application domain, the data collection comprising structured data, semi-structured data, and unstructured data;
annotate the unstructured data into annotated data using predefined metadata defined by the global ontology schema;
map and convert the structured data and the semi-structured data to semantic data into the graph database;
integrate the annotated data with the semantic data in the graph database; and
store the semantic knowledge base in a database.

9. The data processing system of claim 8, further comprising:
importing the annotated data to the graph database using a survey importer.

10. The data processing system of claim 9, wherein the survey importer utilizes a tagger for extracting information related to products or services and tagging the unstructured data to the global ontology schema.

11. The data processing system of claim 8, wherein the structured data and the semi-structured data is converted to semantic data by source specific mappers.

12. The data processing system of claim 8, wherein the unstructured data comprises free text, the semi-structured data comprises webpage data, and the structured data comprises relational database data.

13. The data processing system of claim 8, further comprising displaying the semantic data in a web based interface.

14. The data processing system of claim 13, wherein the web based interface comprises multiple visualization options including a data view, a feedback treemap, a trend graph, a linked terms view, and a geographic map.

15. A non-transitory computer-readable medium encoded with executable instructions that, when executed, cause one or more data processing systems to:
receive a semantic knowledge base related to an application domain, wherein the semantic knowledge base comprises a graph database and a global ontology schema;
receive a data collection related to the application domain, the data collection comprising structured data, semi-structured data, and unstructured data;
annotate the unstructured data into annotated data using predefined metadata defined by the global ontology schema;
map and convert the structured data and the semi-structured data to semantic data into the graph database;
integrate the annotated data with the semantic data in the graph database; and
store the semantic knowledge base in a database.

16. The computer-readable medium of claim 15, further comprising:
importing the annotated data to the graph database using a survey importer.

17. The computer-readable medium of claim 16, wherein the survey importer utilizes a tagger for extracting information related to products or services and tagging unstructured data to domain ontologies.

18. The computer-readable medium of claim 15, wherein the structured data and the semi-structured data is converted to semantic data by source specific mappers.

19. The computer-readable medium of claim 15, wherein the unstructured data comprises free text, the semi-structured data comprises webpage data, and the structured data comprises relational database data.

20. The computer-readable medium of claim 15, further comprising the displaying semantic data in a web based interface.
